(19) United States
(12) Patent Application Publication
(10) Pub. No.: US 2007/0139289 A1
(43) Pub. Date: Jun. 21, 2007

(54) Dipole antenna

(75) Inventors: Chang-Jung Lee, Taoyuan County (TW); Wen-Szu Tao, Hsinchu City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/311,538

(22) Filed: Dec. 20, 2005

(51) Int. Cl. H01Q 9/16

(52) U.S. Cl. 343/792; 343/791

(57) ABSTRACT

A dipole antenna includes a first radiating unit, a second radiating unit and a coaxial transmission line. The first radiating unit, which is hollow tubular, has a first length and a first covering portion. The first covering portion is located at one end of the first radiating unit. The second radiating unit, which is hollow tubular, has a second length greater than the first length, and a second covering portion. The second covering portion is located at one end of the second radiating unit. The coaxial transmission line has a central conductor and an outer grounding conductor. The central conductor is electrically connected to the first radiating unit, and the outer grounding conductor is electrically connected to the second radiating unit.

### BACKGROUND OF THE INVENTION

1. Field of Invention

The invention relates to an antenna and, in particular, to a dipole antenna.

2. Related Art

With the fast advancement of the wireless communication technology, various products and technologies applied in the multi-band transmission field are invented. On the other hand, new products must equip with the wireless transmission function for satisfying the demands of consumers. In a wireless transmission system, the antenna is an important component used to transmit and/or receive the electromagnetic wave. In other words, if there were no antenna, the wireless transmission system could not transmit and receive information. Therefore, the antenna is an essential role in the wireless transmission system.

Choosing the suitable antenna not only can be contributive to collocate the appearance of product and to increase transmission characteristics, but also can decrease the production cost. At present, the commonly used antenna is the monopole antenna, the inverted-F antenna, or the dipole antenna. Herein, the dipole antenna is applied popularly in many communication fields because it can effectively radiate and receive an electromagnetic wave.

Since the designing method and manufacturing materials are different when designing the antenna for varied application products, and the working frequency band are different in different countries, it is very critical for designing the antenna. At present, the common specification of frequency band applied with the Wireless Local Area Network (WLAN) is the IEEE 802.11 standard, which includes 802.11a, 802.11b, and 802.11g standards. In general, the IEEE 802.11a is defined for the frequency band of 5 GHz and the IEEE 802.11b and the IEEE 802.11g is defined for the frequency band of 2.4 GHz.

Moreover, at present, many devices with diversification functions will be integrated in an electronic product. For instance, an access point (AP) and a Digital Enhanced Cordless Telecommunication (DECT) may be integrated in a single electronic product. The electronic product must be configured with two antennas for the AP and the DECT respectively due to the DECT is operated at the frequency band of 1.88 GHz to 1.9 GHz and the AP is operated at the frequency band of 2.4 GHz or 5 GHz. Therefore, the labor hour and the cost are raised.

It is therefore an important subject of the invention to provide an antenna that can integrate the antennas for the WLAN and the DECT.

### SUMMARY OF THE INVENTION

In view of the foregoing, the invention is to provide a dipole antenna, which can be both applied to the WLAN and the DECT.

To achieve the above, a dipole antenna of the invention includes a first radiating unit, a second radiating unit, and a coaxial transmission line. The first radiating unit, which is hollow tubular, has a first length and a first covering portion. The first covering portion is located at one end of the first radiating unit. The second radiating unit, which is hollow tubular, has a second length greater than the first length, and a second covering portion. The second covering portion is located at one end of the second radiating unit. The coaxial transmission line has a central conductor and an outer grounding conductor. The central conductor is electrically connected to the first radiating unit, and the outer grounding conductor is electrically connected to the second radiating unit.

As mentioned above, the dipole antenna of the invention includes the second radiating unit having a length greater than that of the first radiating unit. Thus, the dipole antenna of the invention can be suitable for the frequency bands of the WLAN and the DECT. Therefore, the dipole antenna of the invention can be operated at the WLAN and the DECT so that the manufacture cost can be reduced and thus the product competition can be increased.

### BRIEF DESCRIPTION OF THE DRAWINGS

The invention will become more fully understood from the detailed description given herein below illustration only, and thus is not limitative of the present invention, and wherein:

FIG. 1 is a solid diagram showing a dipole antenna according to an embodiment of the invention;

FIG. 2 is a lateral view of the dipole antenna as shown in FIG. 1;

FIG. 3 is a cross-sectional diagram of the dipole antenna as shown in FIG. 1;

FIG. 4 is schematic diagram showing the dipole antenna according to the embodiment of the invention;

FIG. 5 is another solid diagram showing the dipole antenna according to the embodiment of the invention;

FIG. 6 is a measure diagram showing a working band range of the dipole antenna according to the embodiment of the invention;

FIG. 7a is a measure diagram showing an E-plan of a radiation pattern of the dipole antenna works at 1.88 GHz according to the embodiment of the invention;

FIG. 7b is a measure diagram showing an H-plan of a radiation pattern of the dipole antenna works at 1.88 GHz according to the embodiment of the invention;

FIG. 8a is a measure diagram showing an E-plan of a radiation pattern of the dipole antenna works at 1.89 GHz according to the embodiment of the invention;

FIG. 8b is a measure diagram showing an H-plan of a radiation pattern of the dipole antenna works at 1.89 GHz according to the embodiment of the invention;

FIG. 9a is a measure diagram showing an E-plan of a radiation pattern of the dipole antenna works at 1.90 GHz according to the embodiment of the invention;

FIG. 9b is a measure diagram showing an H-plan of a radiation pattern of the dipole antenna works at 1.90 GHz according to the embodiment of the invention;

FIG. 10a is a measure diagram showing an E-plan of a radiation pattern of the dipole antenna works at 2.40 GHz according to the embodiment of the invention;

FIG. 10b is a measure diagram showing an H-plan of a radiation pattern of the dipole antenna works at 2.40 GHz according to the embodiment of the invention;

FIG. 11a is a measure diagram showing an E-plan of a radiation pattern of the dipole antenna works at 2.45 GHz according to the embodiment of the invention;

FIG. 11b is a measure diagram showing an H-plan of a radiation pattern of the dipole antenna works at 2.45 GHz according to the embodiment of the invention;

FIG. 12a is a measure diagram showing an E-plan of a radiation pattern of the dipole antenna works at 2.50 GHz according to the embodiment of the invention; and

FIG. 12b is a measure diagram showing an H-plan of a radiation pattern of the dipole antenna works at 2.50 GHz according to the embodiment of the invention.

### DETAILED DESCRIPTION OF THE INVENTION

The present invention will be apparent from the following detailed description, which proceeds with reference to the accompanying drawings, wherein the same references relate to the same elements.

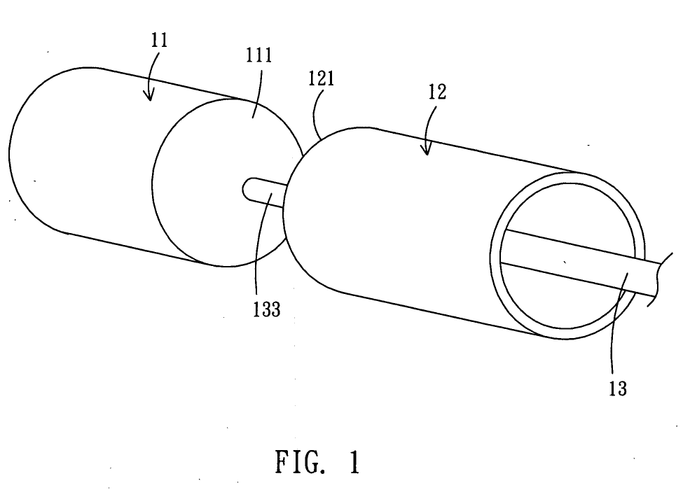

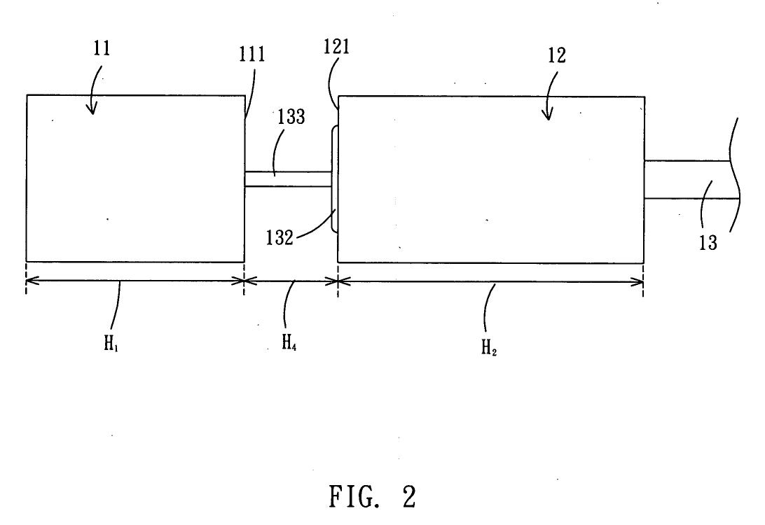

Referring to FIG. 1 and FIG. 2, a dipole antenna 1 according to a preferred embodiment of the invention includes a first radiating unit 11, a second radiating unit, and a coaxial transmission line 13.

The first radiating unit 11, which is hollow tubular, has a first length H₁ and a first covering portion 111. The first covering portion 111 is located at one end of the first radiating unit 11. In the embodiment, the first length H₁ is essentially between 17 mm to 22 mm.

The second radiating unit 12, which is hollow tubular, has a second length H₂ and a second covering portion 121. The second covering portion 121 is located at one end of the second radiating unit 12. In the embodiment, the second length H₂ is essentially between 26 mm to 32 mm.

In the embodiment, a length H₄ from the first covering portion 111 to the second covering portion 121 is essentially between 2 mm to 8 mm.

In addition, the first radiating unit 11 and second radiating unit 12 are made of a metal such as copper.

Furthermore, the first radiating unit 11 and the second radiating unit 12 may be a hollow cylindrical (shown as in FIG. 1) or a hollow square tubular.

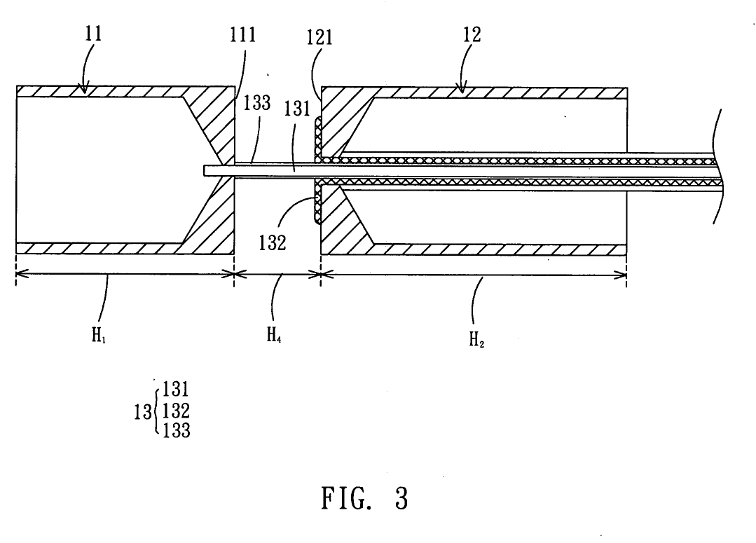

Referring to FIG. 3, the coaxial transmission line 13 has a central conductor 131 and an outer grounding conductor 132, wherein the central conductor 131 is electrically connected to the first radiating unit 11 and the outer grounding conductor 132 is electrically connected to the second radiating unit 12.

In the embodiment, the coaxial transmission line 13 further has an insulation layer 133, which covers the central conductor 131, is disposed between the central conductor 131 and the outer grounding conductor 132. Moreover, the insulation layer is made of Teflon.

Additionally, in the embodiment, the first covering portion 111 has a feeding point, which is electrically connected to the central conductor 131, and the second covering portion 121 has a grounding point, which is electrically connected to the outer grounding conductor 132.

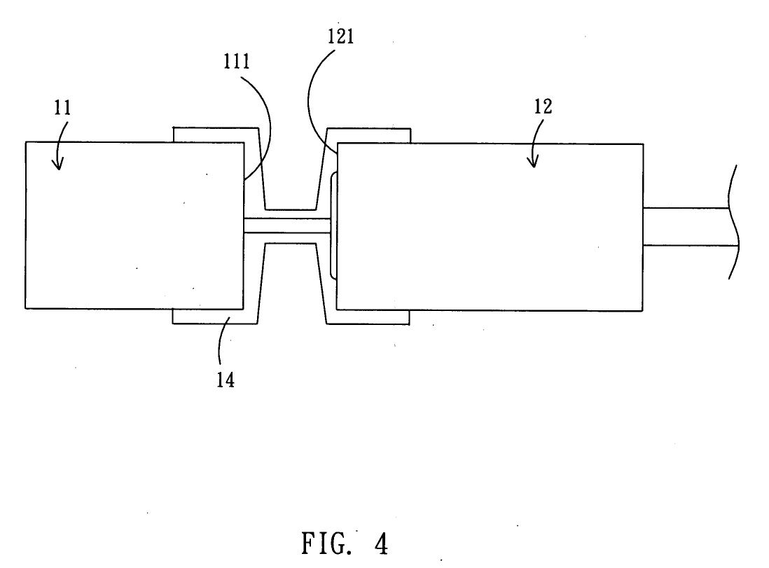

Referring to FIG. 4, the dipole antenna 1 further includes a protecting sleeve 14, which is disposed between the first covering portion 111 of the first radiating unit 11 and the second covering portion 121 of the second radiating unit 12. In the embodiment, the protecting sleeve 14 may be a heat shrinkable poly olefin for enhancing the structure of the dipole antenna.

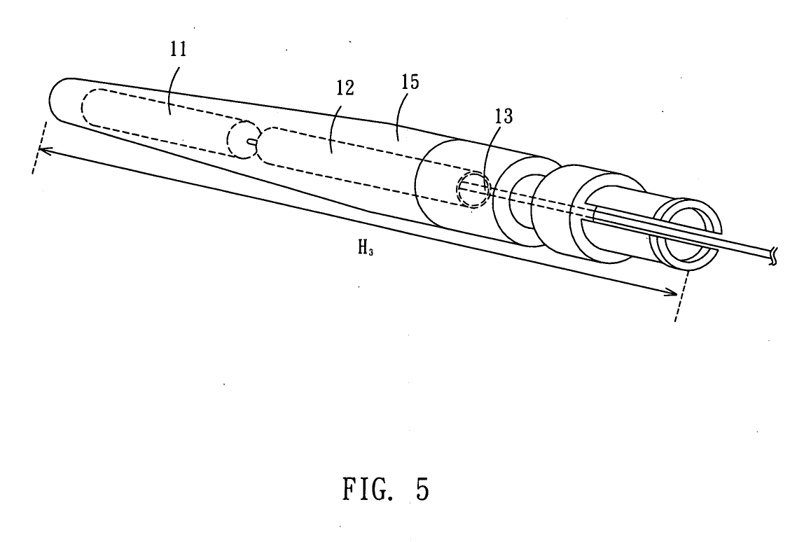

Referring to FIG. 5, the dipole antenna 1 further includes a casing 15 for protecting the dipole antenna 1 to avoid the antenna from damage. The casing 15 has a third length H₃ and covers the first radiating unit 11, the second radiating unit 12, and a part of the coaxial transmission line 13. In addition, the dipole antenna 1 has a better appearance by the suitable casing design. In the embodiment, the third length H₃ is greater than 45 mm and covers the first radiating unit 11, the second radiating unit 12, and a part of the coaxial transmission line 13.

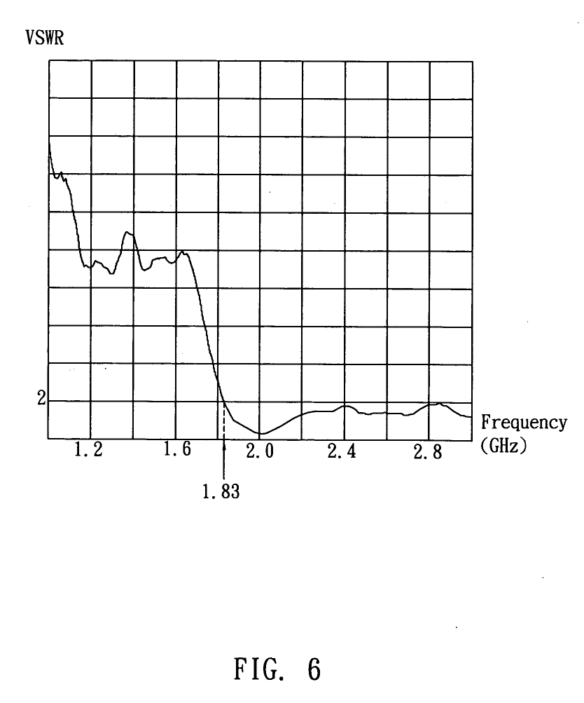

FIG. 6 is a measure diagram showing a voltage standing wave ratio (VSWR) of the dipole antenna according to the embodiment of the invention. With reference to FIG. 6, the vertical axis represents the VSWR, and the horizontal axis represents the frequency. In general, the acceptable definition of the VSWR is smaller than 2. In the embodiment, the dipole antenna 1 according to the embodiment of the invention can work at bands of 1.88 GHz to 2.5 GHz. In other words, the dipole antenna 1 can be used for the antenna of the IEEE 802.11b/g and the DECT. Certainly, the dipole antenna 1 also can be used for the antenna of the IEEE 802.11a and the DECT.

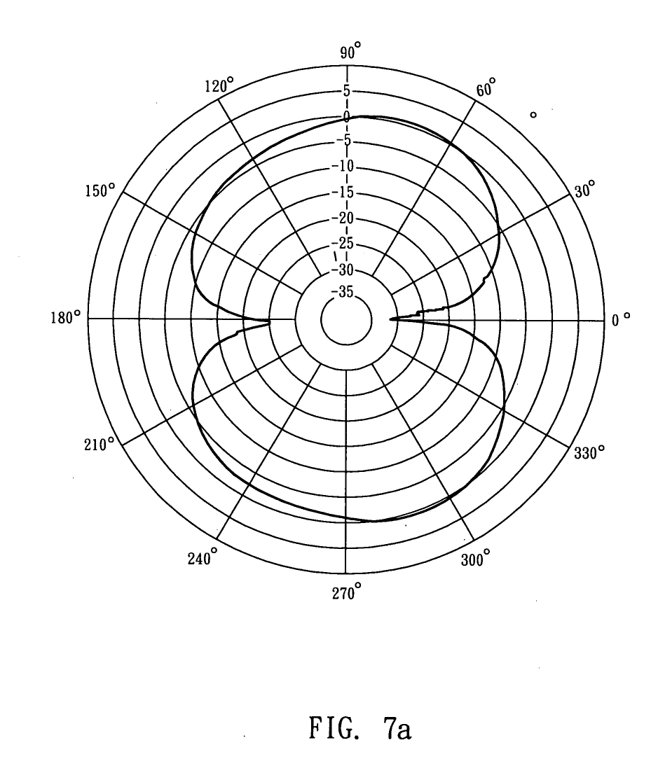

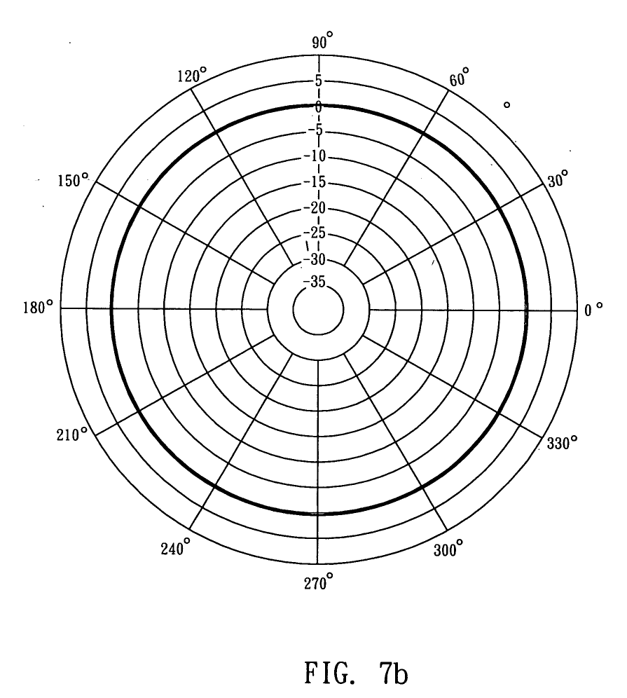

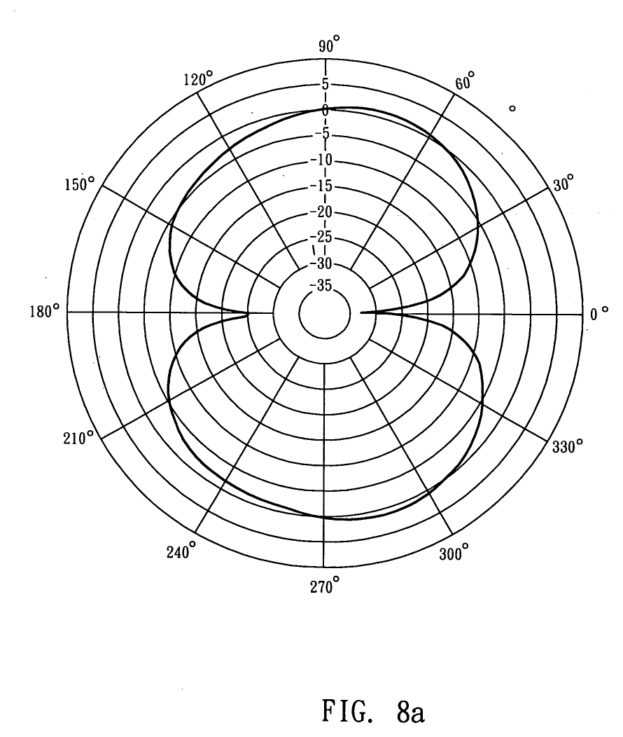

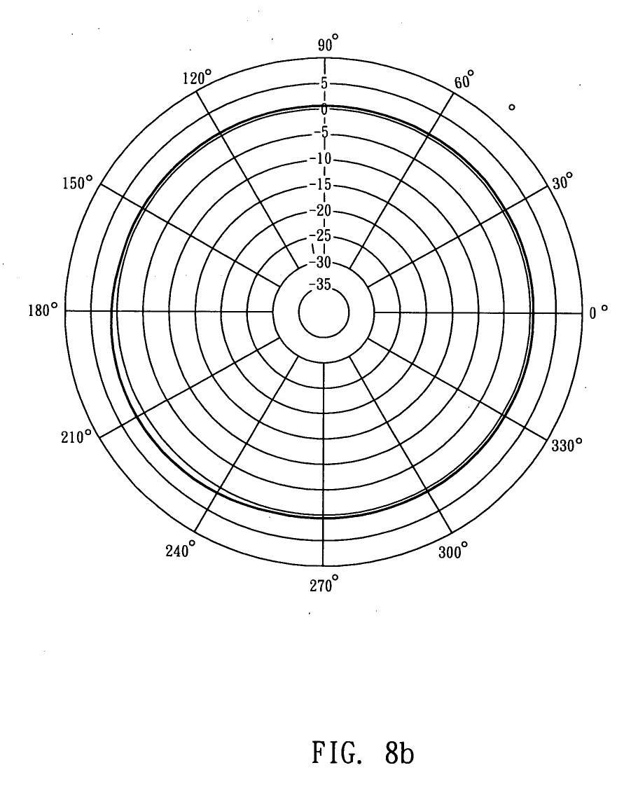

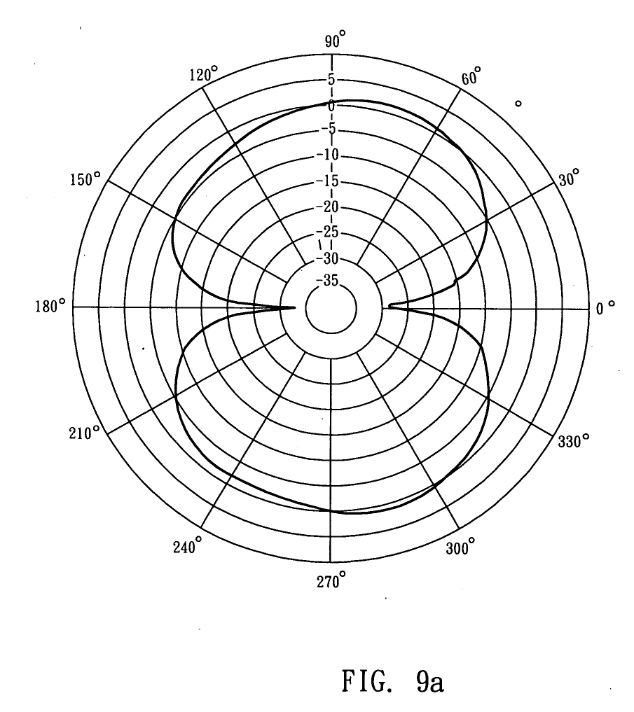

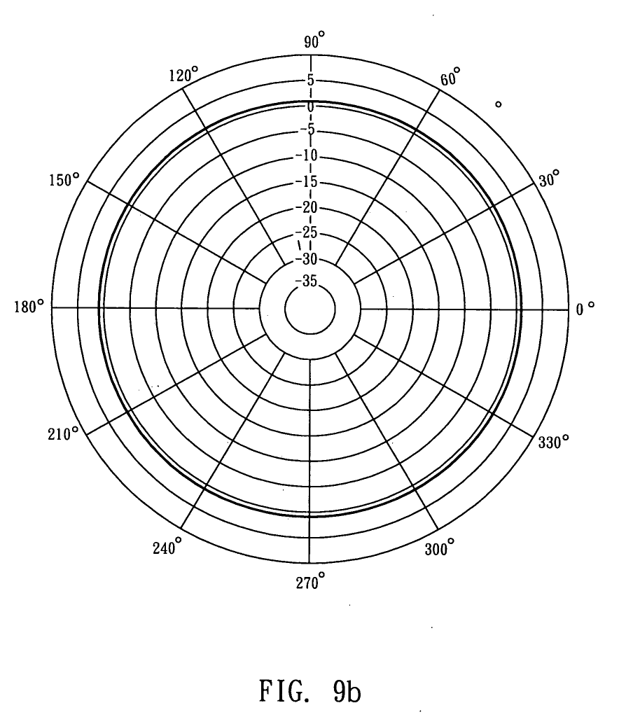

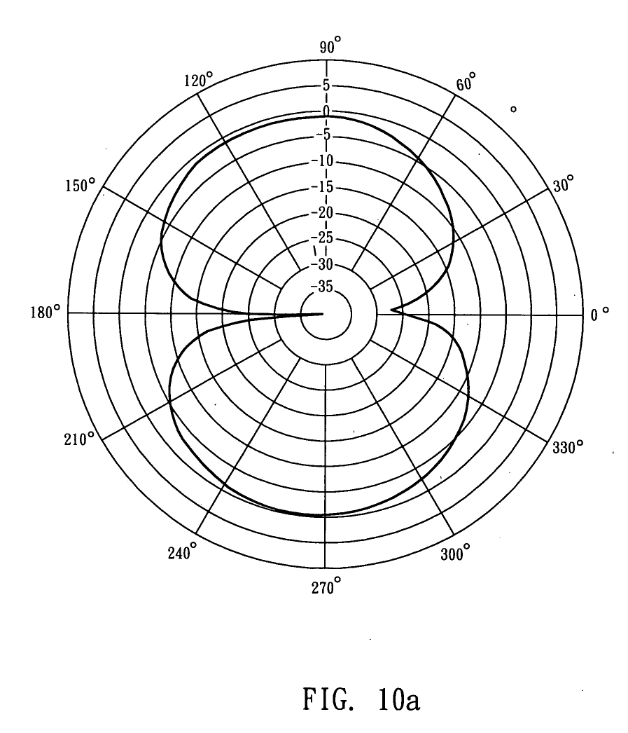

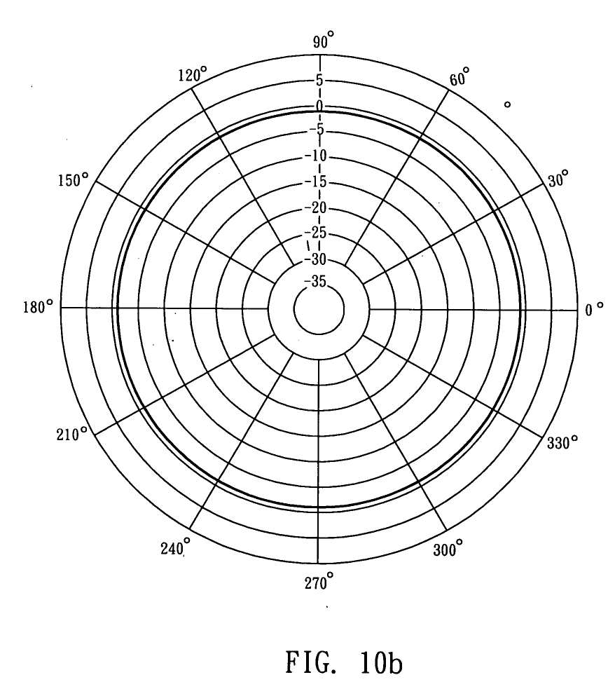

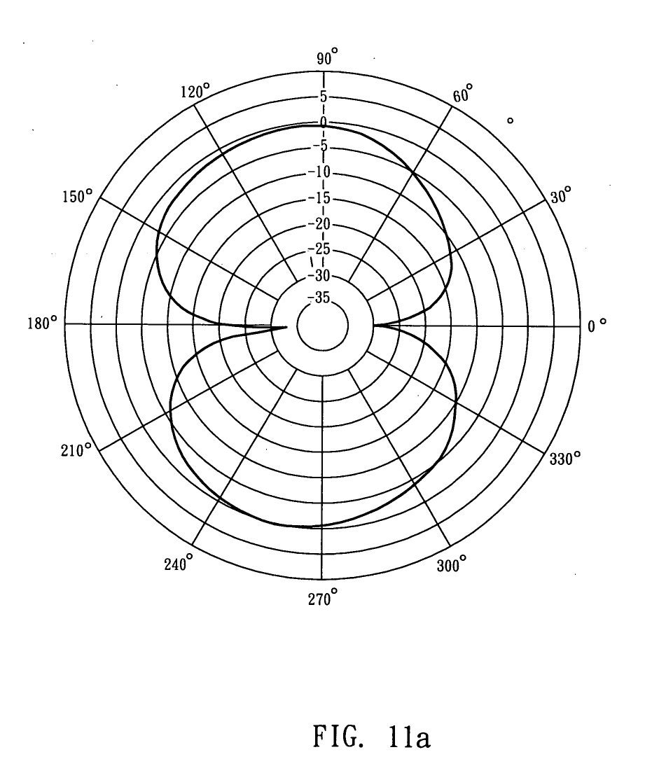

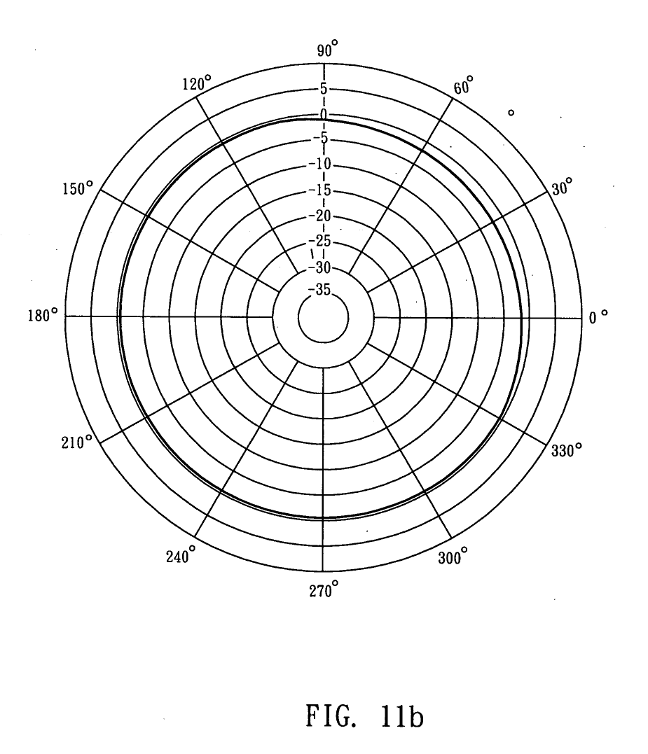

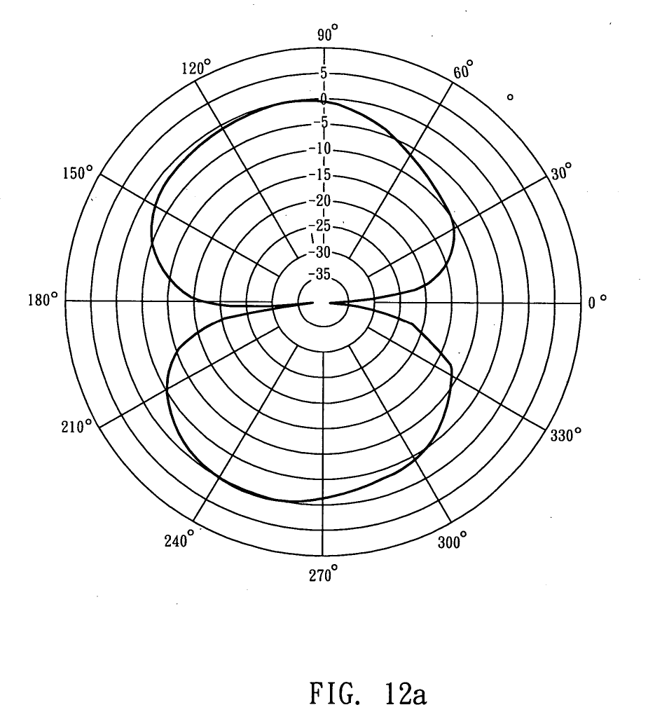

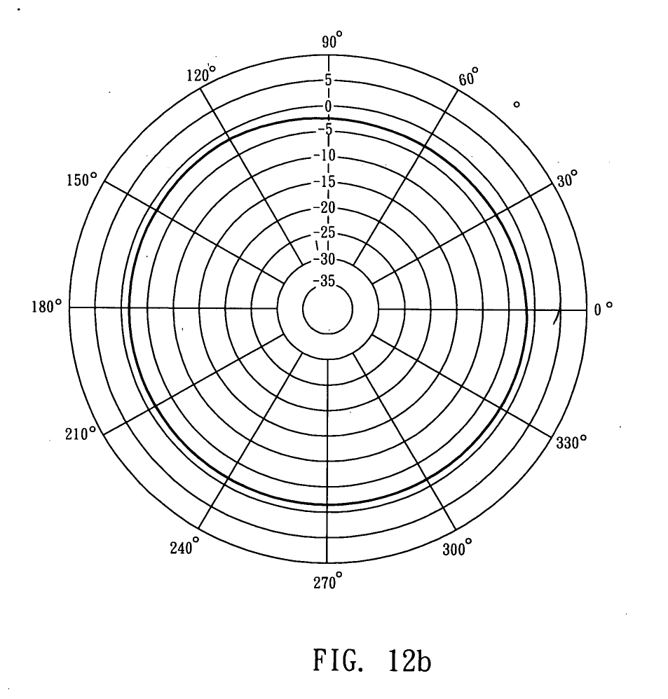

FIGS. 7a, 8a, 9a, 10a, 11a, and 12a are measure diagrams showing an E-plan of a radiation pattern of the dipole antenna 1 operated at the frequency bands of 1.88 GHz, 1.89 GHz, 1.90 GHz, 2.40 GHz, 2.45 GHz, and 2.50 GHz respectively, and FIGS. 7b, 8b, 9b, 10b, 11b, and 12b are measure diagrams showing an H-plan of a radiation pattern of the dipole antenna 1 operated at the frequency bands of 1.88 GHz, 1.89 GHz, 1.90 GHz, 2.40 GHz, 2.45 GHz, and 2.50 GHz respectively. In other words, the dipole antenna 1 can be applied with the IEEE 802.11b/g standards and the DECT simultaneously.

In summary, the dipole antenna of the invention includes the second radiating unit having a length greater than that of the first radiating unit. Thus, the dipole antenna of the invention can be suitable for the frequency bands of the WLAN and the DECT. Therefore, the dipole antenna of the invention can be operated at the WLAN and the DECT so that the manufacture cost can be reduced and thus the product competition can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dipole antenna, comprising:
a first radiating unit having a first length and a first covering portion, wherein the first radiating unit is hollow tubular, and the first covering portion is located at one end of the first radiating unit;
a second radiating unit having a second length greater than the first length, and a second covering portion, wherein the second radiating unit is hollow tubular, and the second covering portion is located at one end of the second radiating unit; and
a coaxial transmission line having a central conductor and an outer grounding conductor, wherein the central conductor is electrically connected to the first radiating unit and the outer grounding conductor is electrically connected to the second radiating conductor.

2. The antenna according to claim 1, wherein the first length is essentially between 17 mm to 22 mm.

3. The antenna according to claim 1, wherein the second length is essentially between 26 mm to 32 mm.

4. The antenna according to claim 1, wherein the first covering portion has a feeding point electrically connected to the central conductor.

5. The antenna according to claim 1, wherein the second covering portion has a grounding point electrically connected to the outer grounding conductor.

6. The antenna according to claim 1, wherein a length of the first covering portion to the second covering portion is essentially between 2 mm to 8 mm.

7. The antenna according to claim 1, wherein the first radiating unit and the second radiating unit are made of a metal.

8. The antenna according to claim 7, wherein the first radiating unit and the second radiating unit are made of copper.

9. The antenna according to claim 1, wherein the coaxial transmission line further comprises an insulator covering the central conductor and disposed between the central conductor and the outer grounding conductor.

10. The antenna according to claim 9, wherein the insulator is made of Teflon.

11. The antenna according to claim 1, which is operated between 1.88 GHz to 2.5 GHz.

12. The antenna according to claim 1, further comprising:
a casing having a third length, wherein the casing covers the first radiating unit, the second radiating unit, and a part of the coaxial transmission line.

13. The antenna according to claim 12, wherein the third length is greater than 45 mm.

14. The antenna according to claim 1, further comprising a protecting sleeve disposed between the first covering portion of the first radiating unit and the second covering portion of the second radiating unit.

15. The antenna according to claim 14, wherein the protecting sleeve is a heat shrinkable poly olefin.

16. The antenna according to claim 1, wherein the first radiating unit is hollow cylindrical.

17. The antenna according to claim 1, wherein the second radiating unit is hollow cylindrical.
